(19) United States
(12) Patent Application Publication
(10) Pub. No.: US 2016/0239407 A1
(43) Pub. Date: Aug. 18, 2016

(54) SMALL SCALE INTEGRATION TEST GENERATION

(71) Applicant: GOOGLE INC., Mountain View, CA (US)

(72) Inventor: Franjo IVANCIC, Mountain View, CA (US)

(73) Assignee: GOOGLE INC., Mountain View, CA (US)

(21) Appl. No.: 14/544,777

(22) Filed: Feb. 18, 2015

(51) Int. Cl. G06F 11/36

(52) U.S. Cl. CPC G06F 11/3684

(57) ABSTRACT

Provided are methods and systems for automated generation of small scale integration tests to keep mocked input-output contract expectations of external objects synchronized with the actual implementation of the external objects. Such synchronization is achieved through automated creation of small scale integration tests by replacing expected input-output behaviors of mocked interactions with actual code sequences of the mocked interaction. The methods and systems utilize automated test generators with search-based software engineering methods to reuse and adapt developer written tests into new automatically generated tests.

### BACKGROUND

Given the increasing role of software in today's society, automated ways of ensuring software quality are becoming even more important. Today's software industry relies heavily on automated software testing using unit tests. However, these unit tests are generally manually written and code coverage metrics such as, for example, statement coverage or modified condition/decision coverage (MCDC), are used to estimate the quality of the manually written tests.

A variety of existing approaches have been developed that allow automated ways of generating unit tests. For example, one existing automated test generation approach is the so-called feedback-directed random test generation technique. Another existing approach relies on symbolic execution based methods, often in conjunction with a concrete test execution termed concolic execution. However, these and other existing automated test generation methods focus on the creation of unit tests due to the inherent complexities associated with testing an entire module of source code, scalability concerns, and generated test justification concerns.

Furthermore, in practice, the test-driven software development process has become the de facto industry standard. Thus, an automated test generation system that does not rely on any developer written tests is likely to be sub-optimal. In particular, automatically generated unit tests from scratch are unlikely to provide much value to the software developer over her manually written unit tests.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

The present disclosure generally relates to methods and systems for testing source code. More specifically, aspects of the present disclosure relate to testing source code through the automated generation of small-scale integration tests.

One embodiment of the present disclosure relates to a computer-implemented method for automated test generation comprising: identifying code objects witnessing an expected input-output behavior of a mocked interaction in a software test; and automatically creating one or more small scale integration tests for the identified code objects, wherein the automatic creation of the one or more small scale integration tests includes replacing expected input-output behavior of the mocked interaction with actual code implementation sequences of the previously mocked interaction.

In another embodiment, the replacing of expected input-output behavior of the mocked interaction with actual code implementation sequences of the previously mocked interaction in the method for automated test generation includes: constructing code using one or more of a fuzz testing technique, a feedback-directed random technique, a constraint-based technique, and tests of the previously mocked interaction; and using the constructed code for the replacement of the expected input-output behavior of the mocked interaction.

In another embodiment, the method for automated test generation further comprises: recursively performing the code construction and the using of the constructed code for the replacement of the expected input-output behavior of the mocked interaction; and building a test suite that relies on tests generated from the recursive performance.

In another embodiment, the method for automated test generation further comprises presenting the one or more small scale integration tests to a user.

In yet another embodiment, the method for automated test generation further comprises using the one or more small scale integration tests in a testing suite.

In still another embodiment, the method for automated test generation further comprises optimizing the testing suite by removing redundancies with a previous version of the testing suite.

Another embodiment of the present disclosure relates to a computer-implemented method for automated test generation comprising: identifying code objects witnessing an expected input-output behavior of a mocked interaction in a software test; and automatically creating one or more small scale integration tests for the identified code objects, wherein the automatic creation of the one or more small scale integration tests includes replacing expected input-output behavior of the mocked interaction with objects captured during unit tests of the mocked interaction.

Yet another embodiment of the present disclosure relates to a system for automated test generation, the system comprising a least one processor and a non-transitory computer-readable medium coupled to the at least one processor having instructions stored thereon that, when executed by the at least one processor, causes the at least one processor to: identify code objects witnessing an expected input-output behavior of a mocked interaction in a software test; and automatically create one or more small scale integration tests for the identified code objects, wherein the automatic creation of the one or more small scale integration tests includes replacing expected input-output behavior of the mocked interaction with actual code implementation sequences of the previously mocked interaction.

In another embodiment, the at least one processor in the system for automated test generation is further caused to replace the expected input-output behavior of the mocked interaction with actual code implementation sequences of the previously mocked interaction using code constructed using a fuzz testing technique.

In another embodiment, the at least one processor in the system for automated test generation is further caused to replace the expected input-output behavior of the mocked interaction with actual code implementation sequences of the previously mocked interaction using code constructed using a feedback-directed random technique.

In yet another embodiment, the at least one processor in the system for automated test generation is further caused to replace the expected input-output behavior of the mocked interaction with actual code implementation sequences of the previously mocked interaction using code constructed from unit tests of the previously mocked interaction.

In another embodiment, the at least one processor in the system for automated test generation is further caused to replace the expected input-output behavior of the mocked interaction with actual code implementation sequences of the previously mocked interaction using code constructed using a constraint-based technique.

In still another embodiment, the at least one processor in the system for automated test generation is further caused to replace the expected input-output behavior of the mocked interaction with actual code implementation sequences of the previously mocked interaction using code constructed using one or more of the following: a fuzz testing technique, a feedback-directed random technique, unit tests of the previously mocked interaction, and a constraint-based technique.

In one or more other embodiments, the methods and systems described herein may optionally include one or more of the following additional features: the expected input-output behavior of the mocked interaction is replaced with the actual code implementation sequences of the previously mocked interaction using code constructed using a fuzz testing technique; the expected input-output behavior of the mocked interaction is replaced with the actual code implementation sequences of the previously mocked interaction using code constructed using a feedback-directed random technique; the expected input-output behavior of the mocked interaction is replaced with the actual code implementation sequences of the previously mocked interaction using code constructed from unit tests of the previously mocked interaction; the expected input-output behavior of the mocked interaction is replaced with the actual code implementation sequences of the previously mocked interaction using code constructed using a constraint-based technique; the constraint-based technique includes relying on constraints generated using symbolic execution; and/or the constraint-based technique includes relying on constraints generated using concolic execution.

Embodiments of some or all of the processor and memory systems disclosed herein may also be configured to perform some or all of the method embodiments disclosed above. Embodiments of some or all of the methods disclosed above may also be represented as instructions embodied on transitory or non-transitory processor-readable storage media such as optical or magnetic memory or represented as a propagated signal provided to a processor or data processing device via a communication network such as an Internet or telephone connection.

Further scope of applicability of the methods and systems of the present disclosure will become apparent from the Detailed Description given below. However, it should be understood that the Detailed Description and specific examples, while indicating embodiments of the methods and systems, are given by way of illustration only, since various changes and modifications within the spirit and scope of the concepts disclosed herein will become apparent to those skilled in the art from this Detailed Description.

### BRIEF DESCRIPTION OF DRAWINGS

These and other objects, features, and characteristics of the present disclosure will become more apparent to those skilled in the art from a study of the following Detailed Description in conjunction with the appended claims and drawings, all of which form a part of this specification. In the drawings:

FIG. 1 is a block diagram illustrating an example unit test according to one or more embodiments described herein.

FIG. 2 is a block diagram illustrating an example small scale integration test based on the example unit test shown in FIG. 1 according to one or more embodiments described herein.

FIG. 3 is a flowchart illustrating an example method for automated generation of small-scale integration tests according to one or more embodiments described herein.

FIG. 4 is a block diagram illustrating an example computing device arranged for automated generation of small-scale integration tests according to one or more embodiments described herein.

The headings provided herein are for convenience only and do not necessarily affect the scope or meaning of what is claimed in the present disclosure.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

### Overview

Various examples and embodiments of the methods and systems of the present disclosure will now be described. The following description provides specific details for a thorough understanding and enabling description of these examples. One skilled in the relevant art will understand, however, that one or more embodiments described herein may be practiced without many of these details. Likewise, one skilled in the relevant art will also understand that one or more embodiments of the present disclosure can include other features not described in detail herein. Additionally, some well-known structures or functions may not be shown or described in detail below, so as to avoid unnecessarily obscuring the relevant description.

As discussed above, existing approaches for automated test generation focus on the creation of unit tests due to inherent complexities associated with testing an entire source code, scalability concerns, and generated test justification concerns. In addition, automatically generating unit tests from scratch, without any reliance on developer written tests, is likely to result in sub-optimal testing that provides little value to the developer over his or her manually written tests.

Accordingly, the methods and systems of the present disclosure utilize automated test generators with search-based software engineering methods to reuse and adapt developer written tests in new automatically generated tests. As will be described in greater detail below, the methods and systems of the present disclosure focus on automated generation of small-scale integration tests rather than unit tests, based on the understanding that manually written unit tests in a test-driven software development process are often strong enough, and the additional mileage provided by automatically generated unit tests is limited.

The methods and systems for automated test generation described herein consider the case of mocked unit tests and how to automate the process of integration tests by focusing on these mocked behaviors, which is something that has not been done in existing approaches for automated test generation. One of the many effects of the methods and systems described herein is that, for example, a software development tool environment will be able to combine manually written tests and then produce new small scale integration tests automatically.

Unit tests generally are excellent at finding implementation bugs of code under development by focusing on a single implementation unit. To increase coverage and sharpen the focus of the testing on the actual class under development, other objects and their interactions are often provided through mocked interfaces or objects that can be considered replacements of the actual implementation of those objects. This also often facilitates faster test execution, since potentially complex object interactions of the mocked environment are omitted and only the input-output behavior is preserved. Thus, mocking of external objects provides a number of important benefits in developing fast and reliable unit tests that capture the intended behavior of the class under test.

However, a strict reliance on such mocked unit tests bares some potential pitfalls. For example, such unit tests generally avoid testing the current and future interaction of objects. As code evolves over time, the implicitly captured input-output assumptions of the mocked external objects are not necessarily tested and can thus drift away from the actual implementation over time.

Accordingly, embodiments of the present disclosure relate to methods and systems for keeping mocked input-output contract expectations of external objects synchronized with the actual implementation of the external objects. As will be described in greater detail below, the methods and systems of the present disclosure are designed to achieve this goal in a number of different ways. For example, in accordance with at least one embodiment described herein, mocked input-output contract expectations of external objects may be kept synchronized with the external objects' actual implementation through the discovery of objects witnessing an expected input-output behavior of a mocked interaction. In accordance with one or more other embodiments of the present disclosure, such synchronization may be achieved through automated creation of small scale integration tests by replacing expected input-output behaviors of mocked interactions with actual code sequences of the mocked interaction. The following provides additional details about each of these approaches.

Witness Object Discovery

In accordance with at least one embodiment of the present disclosure, by discovering (e.g., identifying, determining, etc.) objects witnessing an expected input-output behavior of a mocked interaction, the mocked input-output contract expectations of the objects may be kept synchronized with the actual implementation of the objects. For example, for a given mocked input-output expectation of some object interaction, the methods and systems described herein aim to discover a witness object of the external class that exhibits said behavior. It should be noted that, as code evolves, the witnessing object may change over time. In general, it is expected that such a witnessing object, once found, will remain valid for some time before implementation changes or the internal object representation changes.

Additional details about how to discover a witnessing object, in accordance with one or more of the embodiments described herein, will provided in the sections that follow. To provide some context, however, the following presents some well-known high-level strategies for discovering objects given certain constraints.

Object Capturing.

Under this first existing approach, live objects are captured, either in production or during unit tests of the mocked object class, during their execution. The approach then tests whether any captured object would exhibit the expected input-output contract behavior.

Constructive Approaches:

Another existing approach uses a variety of search mechanisms to generate possible candidate objects that could fulfill the expected input-output contract behavior. The search could include methods to randomly generate test sequences, could rely on symbolic or concolic execution, or could simply rely on a fuzzing of objects, as well as more constraint-based search approaches to object fuzzing. It should be noted that with constructed objects there may be a burden to justify that such a generated object is indeed a valid object.

Automated Generation of Small Integration Tests

Finding or discovering witnessing objects, as described above, alleviates some of the concern that a certain input-output expectation is incorrect, or turns incorrect over time. However, such an approach may not always directly improve the integration testing of object interactions. Therefore, in accordance with one or more embodiments of the present disclosure, in order to provide additional value to the software developer, the methods and systems described herein may generate new small-scale integration level tests that may discover current or future object interaction issues.

For example, additional tests may be generated that are based on the unit tests provided for both the class under test as well as the unit tests provided for the mocked object classes. In accordance with at least one embodiment, the methods and systems described herein provide for the automatic creation of new tests in addition to the provided unit tests, where the new tests are de-mocking at least one level of object interaction. Stated differently, one unit test may be de-mocked by removing one expected input-output contract behavior of some mocked class, by substituting that interaction with an actual object of that class. As in the discovery of object witnesses approach described above, there are a number of ways of generating candidate objects including, for example, object capturing and constructive approaches. In accordance with one or more embodiments of the present disclosure, a constructive approach may be used that relies on the re-use of code sequences taken from the unit tests of the mocked object class.

Test Generation Procedure Overview

The following presents a high-level overview of the test generation process in accordance with one or more embodiments of the present disclosure. Consider a class under test C, and unit test U_{C.m} for a method m of class C. Assume that U_{C.m} interacts with an object x of another class X, using a mocked function call f on x. In particular, the mocked behavior of x.f(i) for some input i (or often for any input satisfying some condition on the input space) is that f returns output o. A unit test U_{C.m} generally first sets up some object c of C using a sequence of operations on c including, for example, a constructor and other method call sequences. This setup may include a generation of the object x as a member of c, or it may be constructed separately as an argument to be passed to m. The unit test then calls m appropriately, and during the actual test execution, the method f using some input i is called on x. The mocked function call to f is intercepted by the test execution and the output o is returned instead. The test proceeds using the provided output value o. Finally, the unit tests generally end in an assertion, which is checking a successful test execution.

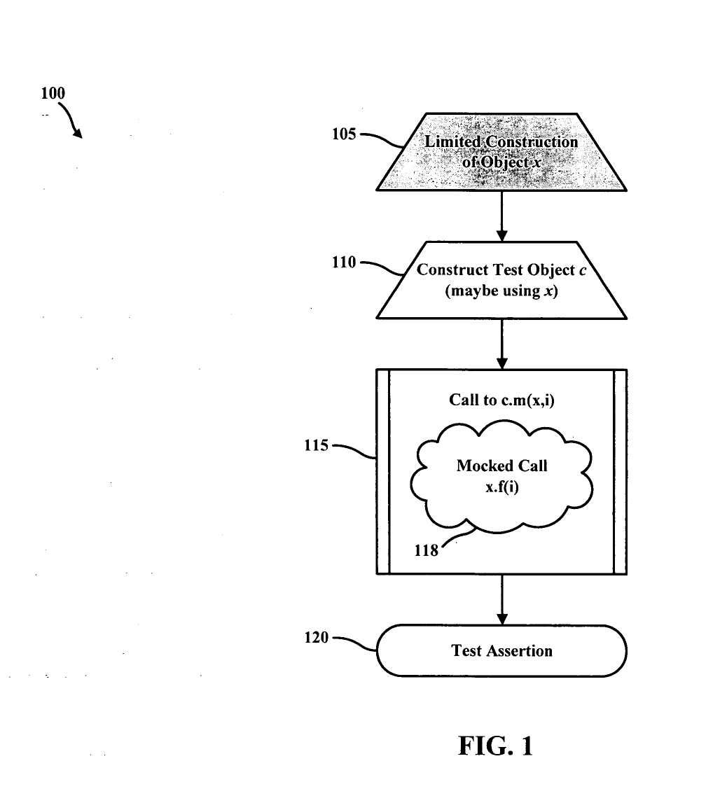

FIG. 1 shows an example unit test of interest in accordance with one or more embodiments described herein. For example, the sample unit test 100 may be for a method C::m using a mocked call to X::f. The sample unit test 100 may construct (105) an object x, which may be used during the construction (110) of the test object of interest, which is c. After a series of method invocations or alterations to c, the test 100 may call (115) the method of interest defined in class C, which is m. For the sake of simplicity of presentation, it may be assumed that x and another input i are passed to the method m. However, it is possible that x is just a member of c and need not be passed along. For simplicity, it may also be assumed that the input i is passed without modification to an internal call to x.f. It should be understood the above assumptions are only made for ease of presentation, and are in no way intended to limit the scope of the present disclosure.

Internally, the method under test C::m calls the method X::f. Since this unit test 100 was designed to test the implementation C::m, the developer mocked (118) out the call to X::f and provides an appropriate return value instead. Since the main use of x is mocked out, the construction of x in the unit test 100 may only be limited/partial (as denoted by the shaded block 105 to differentiate from the non-shaded block 110 for the construction of the test object c). After X::f returns the developer prescribed mock output value to C::m, the computation in C::m completes and the execution returns to the unit test 100. The unit test 100 may end, for example, in some kind of expected outcome test, generally using some kind of test assertion (120) on c or the output of the call c.m.

In accordance with one or more embodiments described herein, the methods and systems of the present disclosure may automatically substitute the intercepted execution off with an actual call to method f on an object x. When executed, the test has a well-defined input value i at the point of the call to x.f(i). To perform an actual call that succeeds to pass the test, it is necessary to find an appropriate object x. In particular, the object x that is currently constructed in the test is unlikely to allow the full test to complete—otherwise, the test would likely not have performed a mocked execution of f (it should be noted, however, that this may not always be true since there are a number of performance reasons why a function call may be mocked out such as, for example, the call to f may end up writing a lot of data to a local file, which would waste test time). As such, it is necessary to find a suitable substitution sequence that generates a candidate object x, which can make sure that the test still passes its test criterion.

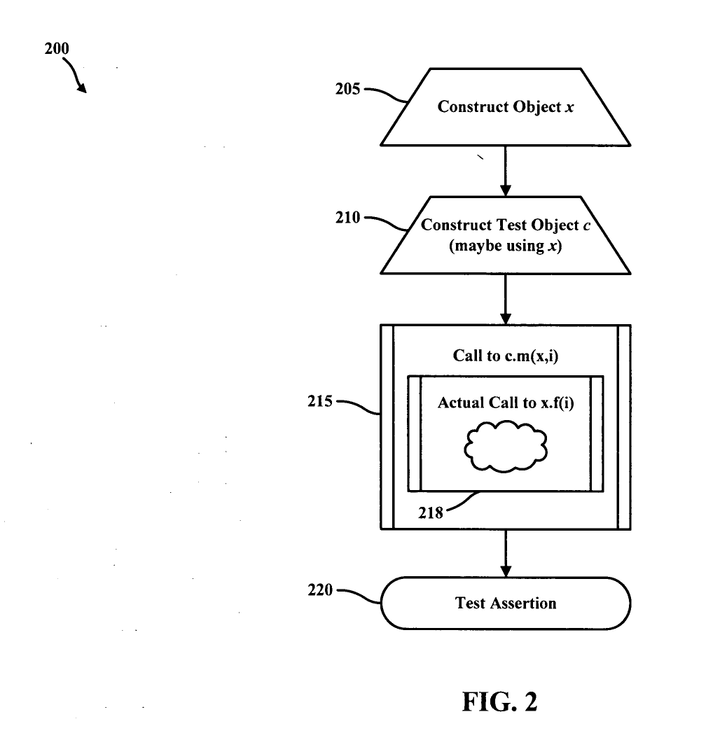

FIG. 2 shows an example of a small scale integration test based on the example unit test described above and illustrated in FIG. 1. In accordance with one or more embodiments described herein, the changed unit test 200 may be for the method C::m using an actual call to X::f. In the example small scale integration test 200 shown in FIG. 2, the limited construction of x in the original unit test (e.g., the limited/partial construction of object x (block 105) in unit test 100 shown in FIG. 1) is changed to allow a complete construction (205) of object x. In addition, the earlier mocked call to x.f(i) (e.g., the mocked call to x.f(i) (block 118) in unit test 100 shown in FIG. 1) has been changed to actually call (218) the actual method x.f. It is important to note, however, that the internals of x.f(i) are allowed to call some mocked method calls.

As described above, there are a number of ways to create candidate objects. For simplicity, the following focuses on one particular object construction method without loss of generality and in no way intending to limit the scope of the present disclosure. In accordance with one or more embodiments, the methods and systems described herein may reuse some unit test U_{C.m} that is one of many such available unit tests for class X to create a suitable object x within the context of the unit test U_{C.m}. It should be noted that it may be assumed that such unit tests for X exist in a test-driven software development process environment. Furthermore, it is also important to note that such unit tests may be parameterizable (e.g., they may have symbolic inputs) and they may depend on mocked interactions with objects of other classes, as well.

The methods and systems described herein can apply by integrating such sequences, which themselves may have other mocked out behaviors, in a step-by-step fashion. Once the initial mocked behavior on function call f has been removed, further concretization of the so generated test may be requested to eliminate other mocked interactions.

Candidate Object Selection

The mocked function call to f specified a particular input-output expectation on the function call f on the object x. Thus, if an object x can be constructed, for which x.f(i) returns o, the mocked function call may be substituted with an actual function call on x. It should be noted that the construction of the object x potentially involves a series of method calls.

While the requirement to find an x, such that x.f(i)=o is straightforward to test, and is sufficient for the test to pass, it is not actually a requirement. It is known that an output value of o will lead the test to pass. However, there may be other output values that would let the test pass as well. In accordance with at least one embodiment of the present disclosure, to allow for greater flexibility, it is not necessary to construct an object x for which x.f(i)=o. Instead, an object x may be constructed for which the unit test U_{C.m} succeeds. Constructing such an object allows for, among other things, more flexibility by increasing the set of feasible objects to be constructed. Therefore, it is possible to find some object x that passes the unit test, even though x.f(i)≠o. However, increasing the search space also increases the complexity of the required analysis. Thus, in practice, it makes sense to first try to construct an object for which x.f(i)=o. In a situation where this construction turns out to be infeasible (e.g., because it cannot be satisfied, because it is taking too much computation time, etc.), the constraint x.f(i)=o may be eliminated and instead an object that satisfies the unit test criterion may be found.

Candidate Object Generation Methods

The following sections describe a variety of example methods that may be used to create (e.g., generate, discover, identify, determine, etc.) candidate objects in accordance with one or more embodiments of the present disclosure. It should be understood that the following examples are not exhaustive, but instead are intended to illustrate some possible techniques for creating candidate objects.

Object Capture

As described above, one way of discovering candidate objects is by capturing objects of the correct runtime type during execution of the production system or during test executions. For example, in accordance with at least one embodiment, the method may include capturing objects that occur during unit testing of the class X for use in unit testing of U_{C.m}. For the present purpose, the feasibility of a captured object x can be tested by applying x.f(i), and checking whether the return value is o. In a second step, even if this first criterion is not met, it can still be tested whether the object x will allow the unit test U_{C.m} to pass even if the output value of x.f(i) is not o.

Sequences from Unit Tests

Another way of discovering candidate objects is by using sequences from unit tests. For example, in accordance with at least one embodiment described herein, it may be assumed that the unit tests for class X follow a similar pattern as described above for unit tests of the class under test C. This is generally the case in a pure testing-driven software development process environment. Thus, it is possible to test the unit tests for feasibility in the unit test U_{C.m} by checking whether appending the method call to f with input i returns o. That is, following a complete unit test of class X (potentially after removing the test assertion), a method call x.f(i) for the tested object x of class X may be appended. If the output value of that method call is o, then it can be determined that the so found test sequence may be used as is in U_{C.m} to generate a newly passing integration test. Again, even if the output value is not o, the unit test for x may still be usable to create a passing integration test.

Argument Transformations for Symbolic and Concolic Test Generation

In accordance with one or more embodiments of the present disclosure, candidate objects may also be created or determined using argument transformation for symbolic and/or concolic test generation.

In order for a constraint-based search to be performed over test inputs, it is necessary to determine some input variables for which various input values may be randomly assigned. As such, certain input variables may be marked as symbolic over some input set domain. However, unit tests rarely contain such symbolic input test variables. Instead, unit tests specify a fixed input value and assert that a certain output is computed. In order to allow a search over inputs for a test case, it may be necessary to abstract such fixed input values and make the corresponding variables symbolic. Such a process is sometimes referred to as “argument transformation.”

In accordance with one or more embodiments described herein, the methods and systems for automated unit test generation of the present disclosure may utilize or incorporate symbolic or concolic test execution. Concolic execution refers to an effective combination of symbolic execution and concrete test runs. In concolic execution based approaches, a set of parameters or inputs of a given test is marked by the user for exploration. For example, the test may first follow the program in accordance with the explicitly given concrete test inputs. Then, in another step, a constraint solver may be used to determine different input values for the set of parameters that can be altered, which would cause a different program path to be taken given the same test program. If such a new input is discovered using the constraint solver (e.g., a Satisfiability Modulo Theories (SMT) solver), the new test is executed and the process may repeat until no more new tests can be found that cover new program paths.

For example, in accordance with at least one embodiment, after argument transformations on the unit tests of X are performed (while potentially removing the test assertion at the end of the unit test), symbolic or concolic execution of the so found test sequences can be searched for inputs that would allow a successful execution of U_{C.m}.

Feedback-Directed Random Test Generation

Another way of creating candidate objects in accordance with one or more embodiments described herein is by using feedback-directed random test generation. Feedback-directed random test generation provides a fully automated way of generating tests for object-oriented programs written in JavaScript. Such a technique automatically generates test drivers containing candidate method sequences of the code under test. If such a generated test driver executes without causing a runtime crash, the current test driver sequence may be considered good and “worth extending” in future runs through random concatenations of such good test drivers. If, however, the generated test driver causes a runtime crash, the test driver may be saved for the user for inspection, and the generated test sequence may be discarded from future sequence generation attempts. The user may then inspect all generated drivers that caused crashes (which may be referred to herein as “crash drivers”). Such crash drivers either expose a real bug in the code under test, or they misuse the provided APIs. The classification whether a crash driver exposes a bug or simply corresponds to a bad method sequence is left to the user.

It should be noted that in the context of the methods and systems described herein, feedback-directed random test generation generates many non-crashing test sequences that are deemed worth extending, as described above. Therefore, in accordance with at least one embodiment of the present disclosure, adding a runtime test at the end of these sequences that would make a successful execution of U_{C.m} possible provides yet another constructive way of generating objects of interest (e.g., candidate objects).

Fuzzing

Yet another way of creating candidate objects is by using brute-force fuzzing or fuzz testing. Fuzz testing randomly generates objects by creating physical object representations through random byte values. Thus, in accordance with one or more embodiments of the present disclosure, the methods and systems described herein could utilize objects created using fuzzing to check whether they could be used to satisfy the unit test requirements in U_{C.m}.

Hybrid Test Approaches

In addition to or instead of the example methods for creating candidate objects described above, one or more embodiments of the present disclosure may utilize a combination of feedback-directed random test generation with concolic execution (sometimes referred to as “hybrid test generators”) for unit test generation. For example, tests generated using feedback-directed random methods may be parameterized so that certain random input values chosen by the test generator in the randomly generated test drivers can be regarded as searchable input spaces for concolic execution. This allows an SMT-solver to extend the randomly generated tests and thus avoids common drawbacks of pure random methods such as, for example, early coverage plateaus. These tests thus contain randomly generated method sequences, and utilize constraint solvers to find relevant input values for such tests. Furthermore, these tests can lead to further crash drivers or new test drivers that can be extended in future iterations of the feedback-directed random test generation step.

One of the many advantages of using a hybrid test generation approach such as the example approach described above is that it allows for a fully automated mechanism to generate tests without user and developer guidance for object-oriented programming languages. Therefore, such hybrid test generation techniques may be applied in one or more embodiments of the methods and systems for automated integration test generation described herein.

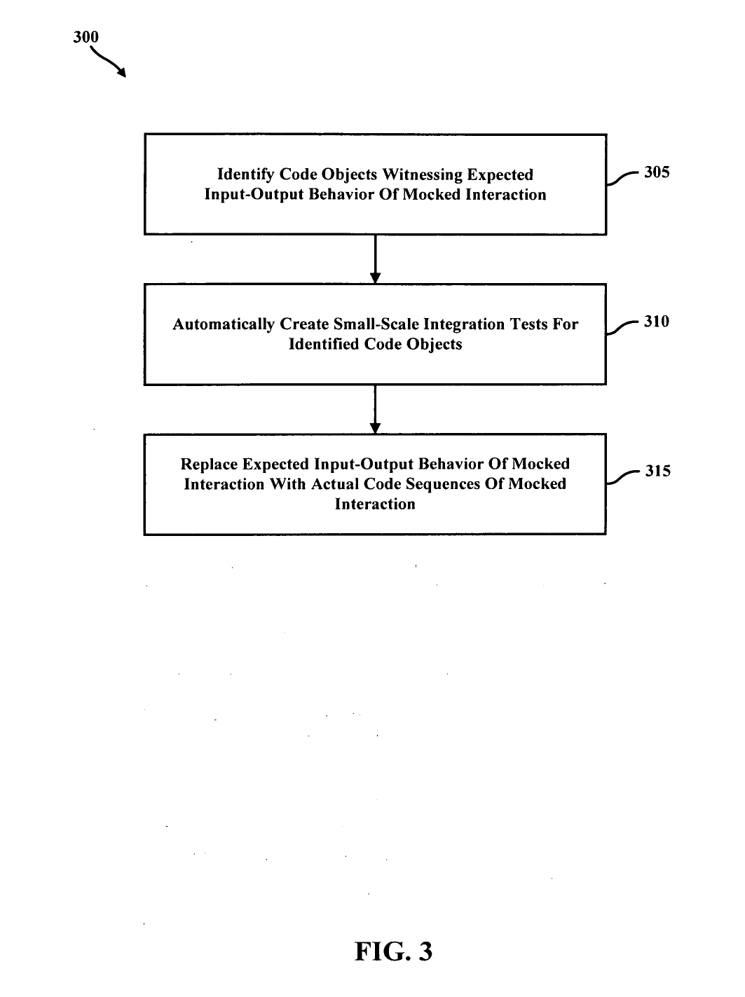

FIG. 3 illustrates an example process for automated generation of small-scale integration tests. In accordance with one or more embodiments described herein, the example process 300 may be performed by a software testing system (e.g., implemented on a computer) configured for use in a software development tool environment.

At block 305 of the example process, code objects (e.g., object x in the example shown in FIG. 1) witnessing expected input-output behavior of a mocked interaction may be identified (e.g., determined, created, etc.). At block 310, one or more small-scale integration tests may be automatically created for the code objects identified at block 305. At block 315, the expected input-output behavior of the mocked interaction may be replaced with actual code sequences of the mocked interaction.

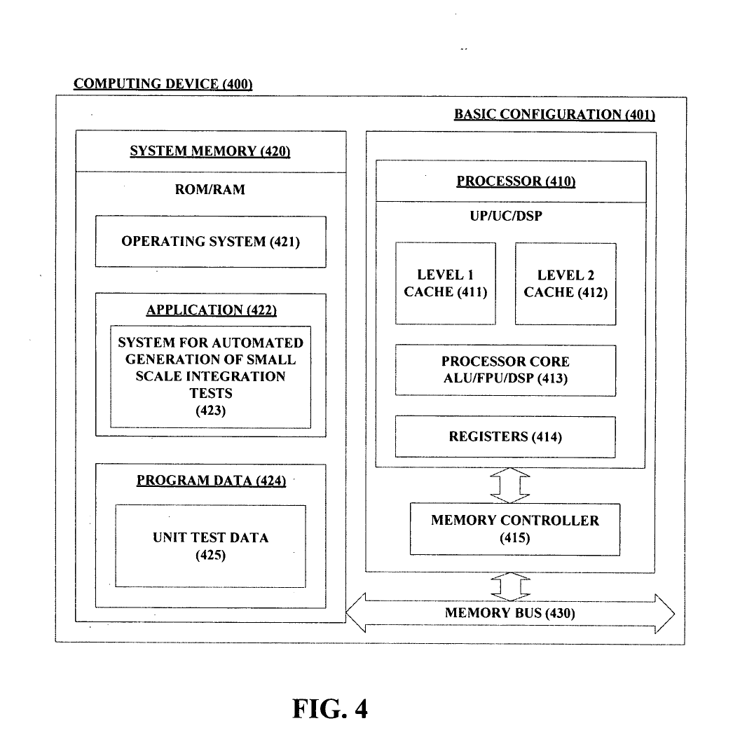

FIG. 4 is a high-level block diagram of an exemplary computer (400) that is arranged for automated generation of small-scale integration tests, in accordance with one or more embodiments described herein. For example, in accordance with at least one embodiment, computer (400) may be configured to automatically generate small-scale integration tests in order to keep mocked input-output contract expectations of external objects synchronized with the actual implementation of the external objects. Such synchronization may be achieved, for example, through the automated creation of small-scale integration tests by replacing expected input-output behaviors of mocked interactions with actual code sequences of the mocked interaction. In a very basic configuration (401), the computing device (400) typically includes one or more processors (410) and system memory (420). A memory bus (430) can be used for communicating between the processor (410) and the system memory (420).

Depending on the desired configuration, the processor (410) can be of any type including but not limited to a microprocessor (μP), a microcontroller (μC), a digital signal processor (DSP), or any combination thereof. The processor (410) can include one more levels of caching, such as a level one cache (411) and a level two cache (412), a processor core (413), and registers (414). The processor core (413) can include an arithmetic logic unit (ALU), a floating point unit (FPU), a digital signal processing core (DSP Core), or any combination thereof. A memory controller (416) can also be used with the processor (410), or in some implementations the memory controller (415) can be an internal part of the processor (410).

Depending on the desired configuration, the system memory (420) can be of any type including but not limited to volatile memory (such as RAM), non-volatile memory (such as ROM, flash memory, etc.) or any combination thereof. System memory (420) typically includes an operating system (421), one or more applications (422), and program data (424). The application (422) may include a system for automated generation of small-scale integration tests (423), which may be configured to keep mocked input-output contract expectations of external objects synchronized with the actual implementation of the external objects, in accordance with one or more embodiments described herein.

Program Data (424) may include storing instructions that, when executed by the one or more processing devices, implement a system (423) and method for automatically generating small-scale integration tests. Additionally, in accordance with at least one embodiment, program data (424) may include unit test data (425), which may relate to data about mocked unit tests, including, for example, data about input-output contract expectations of external objects. In accordance with at least some embodiments, the application (422) can be arranged to operate with program data (424) on an operating system (421).

The computing device (400) can have additional features or functionality, and additional interfaces to facilitate communications between the basic configuration (401) and any required devices and interfaces.

System memory (420) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media can be part of the device (400).

The computing device (400) can be implemented as a portion of a small-form factor portable (or mobile) electronic device such as a cell phone, a smart phone, a personal data assistant (PDA), a personal media player device, a tablet computer (tablet), a wireless web-watch device, a personal headset device, an application-specific device, or a hybrid device that include any of the above functions. The computing device (400) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In accordance with at least one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It should also be noted that in situations in which the systems and methods described herein may collect personal information about users, or may make use of personal information, the users may be provided with an opportunity to control whether programs or features associated with the systems and/or methods collect user information (e.g., information about a user's preferences). In addition, certain data may be treated in one or more ways before it is stored or used, so that personally identifiable information is removed. For example, a user's identity may be treated so that no personally identifiable information can be determined for the user. Thus, the user may have control over how information is collected about the user and used by a server.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for automated test generation comprising:
identifying code objects witnessing an expected input-output behavior of a mocked interaction in a software unit test; and
automatically creating one or more integration tests for the identified code objects by replacing expected input-output behavior of the mocked interaction with actual code implementation sequences of the previously mocked interaction.

2. The method of claim 1, wherein the expected input-output behavior of the mocked interaction is replaced with the actual code implementation sequences of the previously mocked interaction using code constructed using a fuzz testing technique.

3. The method of claim 1, wherein the expected input-output behavior of the mocked interaction is replaced with the actual code implementation sequences of the previously mocked interaction using code constructed using a feedback-directed random technique.

4. The method of claim 1, wherein the expected input-output behavior of the mocked interaction is replaced with the actual code implementation sequences of the previously mocked interaction using code constructed from unit tests of the previously mocked interaction.

5. The method of claim 1, wherein the expected input-output behavior of the mocked interaction is replaced with the actual code implementation sequences of the previously mocked interaction using code constructed using a constraint-based technique.

6. The method of claim 5, wherein the constraint-based technique includes relying on constraints generated using symbolic execution.

7. The method of claim 5, wherein the constraint-based technique includes relying on constraints generated using concolic execution.

8. The method of claim 1, wherein replacing expected input-output behavior of the mocked interaction with actual code implementation sequences of the previously mocked interaction includes:
constructing code using one or more of a fuzz testing technique, a feedback-directed random technique, a constraint-based technique, and tests of the previously mocked interaction; and
using the constructed code for the replacement of the expected input-output behavior of the mocked interaction.

9. The method of claim 8, further comprising:
recursively performing the code construction and the using of the constructed code for the replacement of the expected input-output behavior of the mocked interaction; and
building a test suite that relies on tests generated from the recursive performance.

10. The method of claim 1, further comprising:
presenting the one or more integration tests to a user.

11. The method of claim 1, further comprising:
using the one or more integration tests in a testing suite.

12. The method of claim 11, further comprising:
optimizing the testing suite by removing redundancies with a previous version of the testing suite.

13. A computer-implemented method for automated test generation comprising:
identifying code objects witnessing an expected input-output behavior of a mocked interaction in a software test; and
automatically creating one or more integration tests for the identified code objects by replacing expected input-output behavior of the mocked interaction with objects captured during unit tests of the mocked interaction.

14. A system for automated test generation comprising:
a least one processor; and
a non-transitory computer-readable medium coupled to the at least one processor having instructions stored thereon that, when executed by the at least one processor, causes the at least one processor to:
identify code objects witnessing an expected input-output behavior of a mocked interaction in a software test; and
automatically create one or more integration tests for the identified code objects by replacing expected input-output behavior of the mocked interaction with actual code implementation sequences of the previously mocked interaction.

15. The system of claim 14, wherein the at least one processor is further caused to:
replace the expected input-output behavior of the mocked interaction with actual code implementation sequences of the previously mocked interaction using code constructed using a fuzz testing technique.

16. The system of claim 14, wherein the at least one processor is further caused to:
replace the expected input-output behavior of the mocked interaction with actual code implementation sequences of the previously mocked interaction using code constructed using a feedback-directed random technique.

17. The system of claim 14, wherein the at least one processor is further caused to:
replace the expected input-output behavior of the mocked interaction with actual code implementation sequences of the previously mocked interaction using code constructed from unit tests of the previously mocked interaction.

18. The system of claim 14, wherein the at least one processor is further caused to:
replace the expected input-output behavior of the mocked interaction with actual code implementation sequences of the previously mocked interaction using code constructed using a constraint-based technique.

19. The system of claim 18, wherein the constraint-based technique relies on constraints generated using symbolic execution or concolic execution.

20. The system of claim 14, wherein the at least one processor is further caused to:
replace the expected input-output behavior of the mocked interaction with actual code implementation sequences of the previously mocked interaction using code constructed using one or more of the following: a fuzz testing technique, a feedback-directed random technique, unit tests of the previously mocked interaction, and a constraint-based technique.
